(19) United States
(12) Patent Application Publication
(10) Pub. No.: US 2026/0141062 A1
(43) Pub. Date: May 21, 2026

(54) DETECTING ADVANCED TYPOSQUATTING TECHNIQUES IN SOFTWARE REPOSITORIES USING SEMANTIC ANALYSIS

(71) Applicant: Socket, Inc., Wilmington, DE (US)

(72) Inventors: Feross Hassan Aboukhadijeh, El Dorado Hills, CA (US); Mikola Christopher Lysenko, Midland, MI (US); Wenxin Jiang, West Lafayette, IN (US)

(21) Appl. No.: 19/215,142

(22) Filed: May 21, 2025

Related U.S. Application Data
(60) Provisional application No. 63/722,005, filed on Nov. 18, 2024.

(51) Int. Cl. G06F 21/55

(52) U.S. Cl. CPC G06F 21/554; G06F 2221/034

(57) ABSTRACT

An untrusted package is detected from a system. A name of the untrusted package is input to a machine learning model, and an embedding vector generated as an output. A pool of candidate neighbors of the name of the untrusted package is determined by inputting the embedding vector into a plurality of models, the plurality of models outputting an identification of the conceptual similarity, and a metric associated with the amount of conceptual similarity. A subset of the pool of candidate neighbors based on the respective metrics is selected. Names of each package of the subset is input to a large language model along with respective metadata associated with each respective package of the subset. It is identified whether one or more packages of the subset are sensitive based on the output of the large language model, and an alert is output for each sensitive package.

### CROSS-REFERENCE

This application claims the benefit of U.S. Provisional Application No. 63/722,005, filed Nov. 18, 2024, which is incorporated by reference herein in it entirety.

### BACKGROUND

Software reuse is a fundamental practice in modern development, supported by widespread availability of open-source repositories like Maven and Hugging Face, which help reduce costs and speed up projects. However, this increasing reliance on open-source packages also has exposed software supply chains to security risks, particularly through typosquatting attacks. These attacks involve the distribution of packages with names that are similar to that of legitimate ones, leading developers into installations. Existing typosquatting detection methods lack context awareness, which leads to substantial false positive rates and missed typosquats. This is often a consequence of using partial names to perform limited textual similarity analysis. For ecosystems that use hierarchical naming conventions, such as Maven (e.g. org.apache.commons.io), the attack surface increases as package names grow in depth and complexity. While these naming structures are useful for namespace management, they also create more opportunities for typosquatting. Attackers may change package names at any level of the hierarchy, and as a result, the effective use of textual similarity techniques for detecting such typos is decreased.

### SUMMARY

Systems and methods are disclosed herein that improve typosquatting detection by performing analysis on entire names of packages despite package name length, and robustly performing semantic and structural analysis of package names. Moreover, the system sand methods disclosed herein denoise candidate typosquatting, substantially improving the likelihood that matches do not yield false positives. In an embodiment, when a untrusted package is detected, the system generates a name embedding using a machine learning model. The generated embedding is compared with an existing database of package embedding to identify conceptually similar (e.g., semantic and/or syntactic, etc.) candidate neighbors.

In an embodiment, the system maintains the sensitive package list based on metrics such as popularity statistics, download count, and so on. For each candidate neighbor, the system uses a large language model to jointly analyze name, and metadata of the untrusted package and the candidate neighbor to assess whether the untrusted package is confusable. The system generates an indication if the untrusted package is a potential typosquatting or confusion attack targeting any sensitive packages list.

### BRIEF DESCRIPTION OF THE DRAWINGS

FIG. 1 illustrates one embodiment of a system environment for implementing a typosquatting detection tool, in accordance with an embodiment.

FIG. 2 illustrates a block diagram of the system environment of the typosquatting detection tool, in accordance with an embodiment.

FIG. 3 shows an example illustration of usage of the typosquatting detection tool, in accordance with an embodiment.

FIG. 4 illustrates an exemplary process for operating the typosquatting detection tool, in accordance with an embodiment.

### DETAILED DESCRIPTION

### Overview

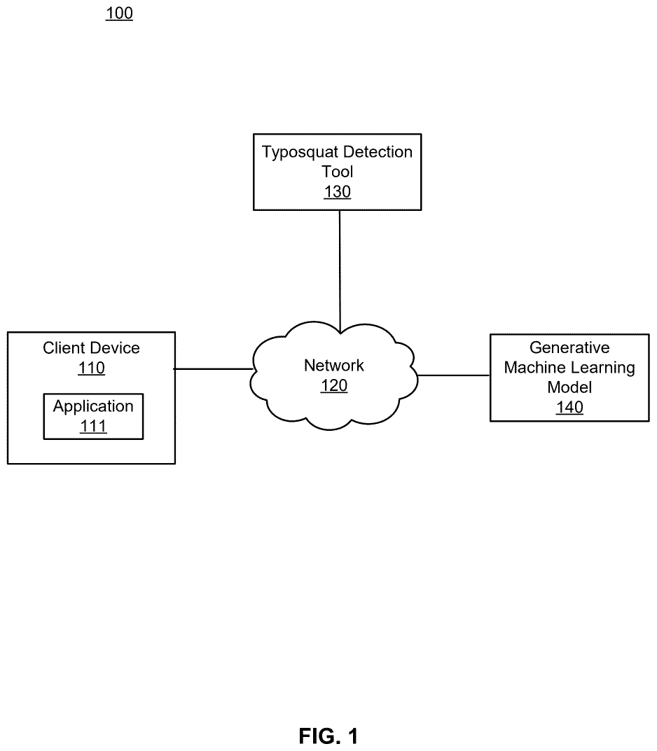

FIG. 1 illustrates one embodiment of a system environment for implementing a malware detection tool, in accordance with an embodiment. As depicted in FIG. 1, environment 100 includes client device 110 (with application 111 installed thereon), network 120, typosquatting detection tool 130, and generative machine learning model 140. While only one instance of each item is depicted, this is for illustrative convenience, and references in the singular to each item is meant to cover instances where plural items exist.

The term typosquatting attacks, as used herein, typically refers to malicious attempts to exploit typographical errors made by users when searching for and/or installing software packages from public registries. These attempts involve publishing packages with names that are intentionally similar, to deceive users into downloading and executing potentially harmful and unauthorized code. Examples of typosquatting package names are often mimicked with small variations (e.g., extra and/or missing letters, misspelling, etc.). The attempts often target poplar open-source libraries that are frequently installed by software developers. In some cases, malicious attempts may involve conceptual and/contextual association that can deceive users. For example, although the words “facebook” and “llama” share no lexical resemblance, they are semantically linked in that Meta (formerly Facebook) released LLaMA language models. Thus, the attempts to publish packages with a name like “llama3-official-api” or “facebook-llama-core” may occur, implying a false affiliation with Meta. Such semantic typosquatting use brand recognition, functional descriptors, ecosystem association, and the like, deceiving users despite the typosquatting having no textual similarity to the legitimate package name.

Optionally, client device 110 may have application 111 installed thereon. Application 111 may provide an interface between client device 110 and typosquatting detection tool 130. Application 111 may receive explicit requests from a user of client device 110 to have typosquatting detection tool 130 identify typosquatting of an untrusted package. Application 111 may monitor for a user (e.g., administrator or developer) accessing and/or attempting to download a package with potential typosquatting attack to an application. Upon detecting such an attempt, typosquatting detection tool may invoke a corresponding alert. Depending on environment of the application, the alert may originate from administrator-managed devices, where typosquatting detection tool is deployed to enforce package usage policies.

Application 111 may be a stand-alone application installed on client device 110, or may be accessed by way of a secondary application, such as a browser application. Any activity described herein with respect to typosquatting detection tool 130 may be performed wholly or in part (e.g., by distributed processing) by application 111. That is, while activity is primarily described as performed in the cloud by typosquatting detection tool 130, this is merely for convenience, and all of the same activity may be performed wholly or partially locally to client device 110 by application 111.

Network 120 facilitates transmission of data between client device 110, typosquatting detection tool 130, and generative machine learning model 140, as well as any other entity with which any entity of environment 100 communicates. Network 120 may be any data conduit, including the Internet, short-range communications, a local area network, wireless communication, cell tower-based communications, or any other communications.

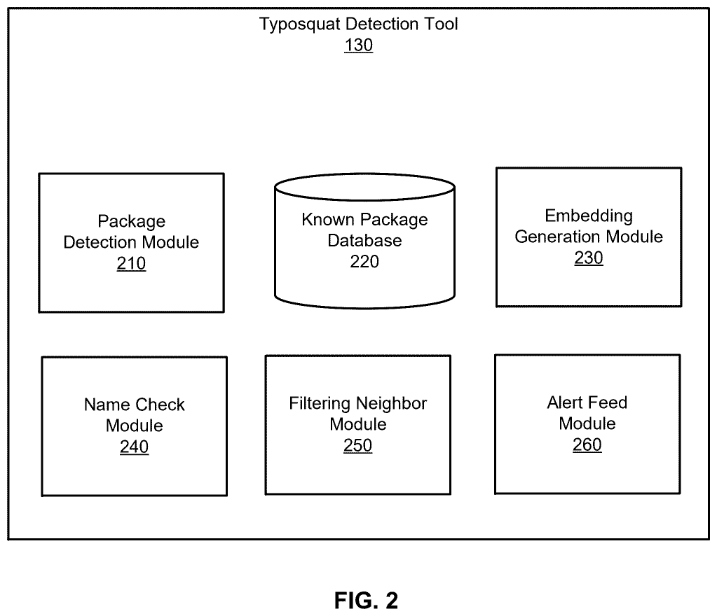

Typosquatting detection tool 130 may determine one or more packages associated with typosquatting detection. Generative machine learning model 140 may be used by typosquatting detection tool 130 to detect typosquatting. While depicted apart from typosquatting detection tool 130 as a third-party service, generative machine learning model 140 may be integrated with typosquatting detection tool 130 as a first-party service. Typosquatting detection tool 130 may have its functionality distributed across any number of servers, and may have some or all functionality performed local to client devices using application 111. Further details about typosquatting detection tool 130 and generative machine learning model 140 are disclosed below with respect to FIGS. 2-4.

### Typosquatting Detection Tool Particulars

FIG. 2 illustrates a block diagram of the system environment of typosquatting detection tool, in accordance with an embodiment. As depicted in FIG. 2, typosquatting detection tool 130 includes package detection module 210, known package database 220, embedding generation module 230, name check module 240, filtering neighbor module 250, and alert feed module 260. The modules and databases depicted in FIG. 2 are merely exemplary, and more or fewer modules and/or and all functionality disclosed herein. It is also reiterated that any and all functionality disclosed with respect to typosquatting detection tool 130 may be performed local to client device 110 by application 111.

Package detection module 210 detects an untrusted package. An “untrusted package” refers to the package that is not recognized by the existing system and/or database. For example, the system may detect a package through an automated crawling operation; however, when a user attempts to access to the package, the system may fail to identify the package at that moment. Thus, the package is considered a “untrusted package”. Package detection module 210 may determine the untrusted package by monitoring package registries within the system environment. Package detection module 210 may observe installation and/or access attempts to identify packages that are not present in the known package database 220.

Known package database 220 maintains historical records of previously downloaded, approved, and/or recognized packages across the system. Known package database 220 may be maintained using metadata database that consolidates package information (e.g., name, version, authorship, licensing information, and publication history, etc.) across various ecosystems (e.g., npm, PyPI, Maven, etc.). The metadata database may be updated at regular and/or irregular intervals to ensure timely detection and reduce the risk of stale or outdated data.

Responsive to detecting an untrusted package, package detection module 210 may extract metadata of the untrusted package and trigger embedding generation module 230 to generate a respective embedding vector of the untrusted package name. Embedding vector allows the system to detect potential typosquatting attempts based on lexical and/or semantic similarity.

Embedding generation module 230 receives the untrusted package name and creates an embedding vector of the untrusted package name. The embedding generation module 230 converts each name into an embedding, using a pretrained machine learning model (e.g., FastText, Character-level CNN, BERT, LSTM, etc.) that captures semantic and/or structural patterns. (e.g., character sequence, word shape, orthographic features, morphological structures, etc.). This approach may be beneficial in ecosystems with massive warehouses of libraries, not only facilitating rapid look ups but also supporting subsequent steps in nearest neighbor search. For instance, package names “meta-llama” and “facebook-llama” look similar, however may not be detected by lexical similarity. Moreover, domain naming conventions (e.g., org.project.module.util.example) may impose a possibility of malicious variations to long and/or hierarchical name.

Name check module 240 may use the embedding vector received from embedding generation module 230 to perform a nearest neighbor search to retrieve existing packages names that are semantically similar based on the proximity within the embedding space. Neighbors satisfying a criterion (e.g., within a threshold distance in embedding space from a target name) may be determined using the clustering model. Name check module 230 may output an identification of the existing package names that are conceptually similar, optionally including a metric representing the degree of conceptual similarity (e.g., semantic distance).

Name check module 240 determines the list of candidate neighbors (“candidate package names”) of the untrusted package names. Candidate package names refer to existing package names in known package database 220 that are conceptually similar, syntactically and/or semantically, to the untrusted package name, with potential to be a target of typosquatting. Name check module 240 performs a nearest neighbor search between the untrusted package name and each candidate package name. For lexical and/or syntactic similarity, name check module 240 may use Levenshtein distance, which measures the minimum number of character edits required to transform one string to another string.

For instance, to calculate Levenshtein distance between two package names, name check module 240 transmits input to generative machine learning model 140. Generative machine learning model 140 prepares a two-dimensional matrix. The first dimension (“row”) represents the characters of the untrusted package name “qeury”, and the second dimension (“column”) represents characters of the candidate package name “query”. The row and column are initialized with ascending integers (e.g., 0, 1, 2 . . . ) to represent the cost of inserting, and/or deleting to reach the initial state. Name check module 240 may then fill the reset of the matrix, as it calculates the minimum cost of three possible operations (e.g., insertion, deletion, and/or substitution) for each character of the cell in the matrix. If the characters are same, the substitution cost is 0, otherwise the cost is 1. The cost of substitution is added to the value from the diagonal cell, while the costs for insertion and deletion are taken from the top or left cell respectively. Once the matrix is filled, the bottom-right cell indicates Levenshtein distance of 1.

To prevent typosquatting attempts with attackers naming a package to with semantic similarity, name check module 240 may use vector embeddings and apply a cosine similarity method between the embeddings of the untrusted package and each candidate packages. Depending on the configuration of the system, name check module 240 may adapt a combination of distance models and/or additional similarity metrics such as n-gram overlap, phonetic similarity, fuzzy ratio, and etc.

In one embodiment, name check module 240 may apply additional filtering to the list of candidate package names to exclude highly popular and renown resources. Detecting malicious attempts for typosquat through large-scale comparison may incur substantial computation overhead and generate false positives. To address this, the system may exclude packages with high popularity and trusted resource names. Popularity metrics refer to measurable indicators such as a number of downloads over a time period, a number of dependencies, ecosystem score and etc. Packages with the most download counts and widely used within the domain are generally considered legitimate and less likely to be typosquatting attempts. For example, name check module 240 may use threshold metrics, e.g., download rate at least 10 times higher than that of the untrusted package, and ecosystem score that are 2 times higher than that of the untrusted packages score.

In another embodiment, typosquatting detection tool excludes CLI strings from being part of the list of candidate package names to prevent false positive and reduce unnecessary computation. CLI (Command-Line Interface) strings refer to commonly used command names or tools that are executed from the terminal, such as npm, pip, git or bash. As widely recognized as legitimate tools within software development environments, including them in the list of candidate package name may lead to false positives. For example, because CLI strings often being short (e.g., help, debug, init, start), may appear similar to many other package names. Thus, by excluding such trusted resources, the system can optimize computation performance and reduce the likelihood of flagging legitimate packages.

Name check module 240 may also select a subset of candidate package names based on the respective metrics. That is, name check module 240 may apply a predefined threshold to filter and retain only the candidate package names with substantial conceptual similarity, substantial defined through some threshold metric (e.g., top X names by semantic distance; apply threshold minimum semantic distance and filter out candidates that are below that threshold, etc.). The list of ranked (and possibly truncated) candidate package names is then propagated to filtering neighbor module 250 for further benignity evaluation.

Filtering neighbor module 250 receives the list of ranked candidate package names from name check module 240. In some embodiments, the filtering neighbor module 240 may further truncate the candidate list by identifying candidates that could not possibly be targeted of typosquatting. For example, filtering neighbor module 240 may determine creation dates of both the untrusted package and a suspected package based on the corresponding metadata. If the creation date of the suspected package predates that of the untrusted package, the suspected package is excluded from the list of ranked candidate packages, even if the names are conceptually similar. This is because the suspected package could not be a typosquatting of the untrusted package as the untrusted package did not exist and was not named at the time the suspected package was created.

Further, the system may use generative AI (e.g., LLMs) to evaluate typosquatting attempts using contextual understanding and semantic similarity. However, such LLMs are computationally expensive and likely to introduce latency. By sorting the list of ranked candidate packages and filtering further noise, the system ensures that ambiguous and high-potential candidate packages are escalated to generative machine learning model 140, which significantly improves computing performance of the system while capturing subtle typosquatting attempts. That is, LLM usage is limited only to high risk package analysis, thereby minimizing LLM usage and improving computational efficiency for typosquat detection.

Filtering neighbor module 250 requests generative machine learning model 140 to determine whether each candidate package name in the list is indicative of a typosquatting attempt (e.g., a benignity check to determine whether a suspected typosquatting attempt is actually benign). Generative machine learning model 140 receives the selected subset of candidate package names along with respective metadata from the known package database 220. Metadata herein refers to structured information that describes the packages which may include but not limited to version history, author or maintainer info, timestamp, summary, and etc.

These metadata as inputs to the large language model (LLM) help determine legitimacy of the package. The LLM-based filtering mechanism provides several advantages to the design of the input prompt, which may be iteratively optimized using production data. The fine-tuning of the prompt significantly improves the model's ability to distinguish between benign and malicious packages by incorporating contextual signals in the metadata.

An example of the input, structured in JSON format may be as below:

```
{
  “package_metadata”: {
    “name”: “qeury”,
    “author”: “abcde”,
    “description”: “An EXAMPLE library”,
    “version_history”: [
      {
        “version”: “0.0.1”,
        “release_date”: “2001-01-01”,
        “release_log”: “Creation of the package.”,
        “files_size_kb”: 150231,
        “dependencies”: [“examplelib3”, ...],
        ...
      },
      {
        “version”: “0.0.2”,
        “release_date”: “2001-02-20”,
        “release_log”: “Minor bug fixes and improvements.”,
        ...
      },
      ...
    ]
    “readme”: “{readme_content}”,
    ...
    “candidate_list”: [
        {
          “target_package”: “{target_package_name_1}”,
          “metric”: “Levenshtein”,
          “distance_score”: 1
          ...
        },
        {
          “target_package”: “{target_package_name_2}”,
          “metric”: “cosine similarity”
          “similarity_score”: 0.98,
          ...
        },
        ...
      ]
  },
  “output_instructions”: {
    “output_category”: [“category 1”, “category 2”, ...],
    ...
    }
  },
  ...
}
```

As shown in the example, such information is needed as the input to the LLM to provide essential context about the untrusted package because the LLM itself may not infer from the name or description alone. In details, the “package_metadata” includes basic attributes of the untrusted package such as the “name”, “author” (e.g., maintainers/organizations), and “description”. An array of “version_history” attribute may refer to chronological data of the untrusted package, identifying each release with date or history log of the package creation or modification, file size, dependencies and etc. The attribute “readme” may include a snippet or the full text of the untrusted package's README file, for the README file or an equivalent documentation oftentimes is included in each of the package detailing its purpose, usage and key features. Such information of the untrusted package may work as another context to determine benign or malicious, by helping the LLM better understand the intended function of the untrusted package and detect any suspicious behavior (e.g., copied description of known packages). In this way, the LLM may cross-reference it with other metadata attributes and candidate list. The “candidate_list” provides an array of target packages each representing a known package that the untrusted package is targeting. Each entry may include “target_package”, name of the corresponding known package, and “distance_score” and/or “similarity_score” which shows the degree of conceptual similarity between the untrusted package and the known package based on predefined “metrics” that was used, such as Levenshtein distance and/or cosine similarity from name check module 240.

Through this benignity check, the LLM may provide further confidence as to a determination of whether the untrusted package is benign, malicious or suspicious. The possible outcome of the LLM includes categorizing the package into level of risks and generating detection rules that may further help identify similar malicious packages in the future.

The large language models are large-scale models that are trained on a large corpus of training data. For example, when the model is an LLM, the LLM may be trained on massive amounts of text data, often involving millions or billions of words or text units. The large amount of training data from various data sources allows the LLM to generate outputs for many inference tasks. A machine learning model may have a significant number of parameters in a deep neural network (e.g., transformer architecture), for example, at least 1 billion, at least 50 billion, at least 100 billion, at least 500 billion, at least 1 trillion, at least 2 trillion parameters.

Thus, the LLM generates an output based on package metadata and contextual analysis. If the untrusted package is flagged to be sensitive, an alert is generated. The alert may contain relevant information about the untrusted package, and transmitted to alert feed module 260 for further processing.

Alert feed module 260 collects alerts generated for sensitive package and embeds each alert into a dynamic threat feed that is frequently updated. Alert feed module 260 monitors real-time user interactions with each sensitive package, such as downloads and installations and sorts the dynamic feed according to levels of user activity. The sorted dynamic feed enables users to take remedial actions toward sensitive packages, with an emphasis on packages most likely to be exploited for future threats. A untrusted package that is determined as sensitive may already have been in user interaction by the time it was flagged by the system as package ecosystems are public. As soon as a untrusted package is uploaded on the ecosystem, it is available for anyone to download and/or install. There may be times when users and/or systems unknowingly install this sensitive package, exposing threat of typosquatting to the user system: in such embodiments, alert feed module 260 may provide a provisional alert to users as lighter warning which does not block the installation of the sensitive package.

Alert feed module 260 includes a threshold for the alerting system. Responsive to detecting sensitive packages that exceed the threshold for the alerting system, alert feed module 260 may escalate an alert for further human triage. The human reviewers may access data to validate whether the typosquatting attempt was real and, where the typosquatting attempt is real, the human reviewer may upgrade the alert to a critical alert. In some embodiments, alert feed module 260 may block installation of sensitive packages associated with a critical alert. Where human review reveals the sensitive package to be a false positive and is not actually a typosquatting attempt, no further action is executed. Alert feed module 260 may prioritize threats for human reviews based on the recency and user impact, meaning, typosquatting attempts that are newer and involve higher user interactions receive faster attention of the system. Moreover, based on the alert received, the users are able to configure security profile of their system, for example, setting more sensitive threshold to triggers frequent alert whenever suspicious attempt is picked up.

Furthermore, alert feed module 260 may perform analysis on the set of human-verified outcomes, either false positive or true positives, in order to better identify the signals most predictive of legitimate threats. To evaluate, alert feed module 260 uses a predefined set of metadata-based features and computes an alert score based on a weighted sum of these features. Using feedback from human triage review, the weights maybe learned and/or adjusted, and which may improve an ability of typosquatting detection tool 130 to prioritize and determine typosquatting threats with increase accuracy.

### Exemplary Use Case

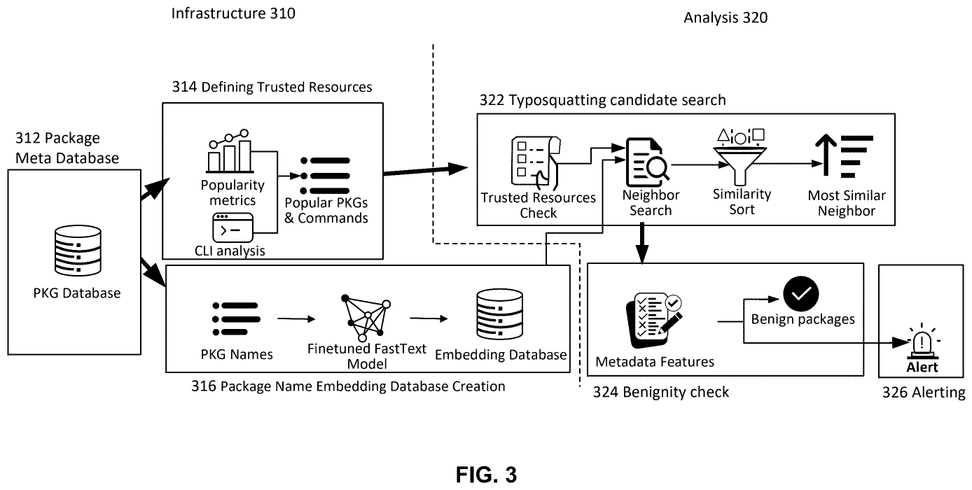

FIG. 3 shows an example illustration of typosquatting detection system, in accordance with an embodiment. As shown in FIG. 3, infrastructure 310 represents the preparation of foundational data and models used for typosquatting detection. Infrastructure 310 includes building a package metadata database 312, defining trusted resources based on popularity metrics and CLI command analysis 314, and creating an embedding database of package names using a fine-tuned model 316. Analysis 320 shows an operational pipeline of how untrusted packages are evaluated. Upon receiving a package, a candidate package search 322 is performed. A benignity check 324 is conducted by analyzing metadata features of the package. For packages failing the benignity check, an alerting mechanism is triggered 326. Depending on the configuration of the system, both the infrastructure and analysis pipeline may be modified or extended to support additional ecosystems.

As part of infrastructure 310, typosquatting detection tool 130 stores 312 metadata of packages in package metadata database. Typosquatting detection tool 130 defines 314 trusted resources that attackers may choose to impersonate. The term trusted resources, as used herein, may refer to resources considered trustworthy based on one or more trust markers, such as having higher popularity and generality within a domain. Typosquatting detection tool 130 creates a list of trusted resources by using popular metrics and performing CLI analysis, for future use in trusted resource check process. The created list of trusted resources is maintained in known package database 220. Embedding generation module 230 creates 316 the vector embedding of the untrusted package using such models e.g., Finetuned FastText Model and stores in the embedding database, which is later used in candidate neighbor search process.

Analysis 320 includes components 322, 324 and 326. Typosquatting detection tool 130 searches 322 packages with a potential of being a typosquatting target. Responsive to receiving a package, package detection module 210 identifies whether the package is present in the known package database 220. Responsive to identifying the package as an untrusted package based on it not being present in the known package database 220, and assuming that embedding generation module 230 created the respective embedding vector of the untrusted package, name check module 240 performs a trusted resource comparison to determine whether the untrusted package name is conceptually similar to each package name from known package database 220 and create the list of candidate package.

Filtering neighbor module 250 retrieves metadata of each candidate package of the list, and performs 324 benignity check and calculate a risk score associated by LLM, determining whether the untrusted package is benign or not. For the untrusted package passing the benign check, it is annotated as a benign package and added to the trusted resource, otherwise, if it fails the benign check, alert feed module 260 creates an alert 326 for further triage and/or review by security analysts.

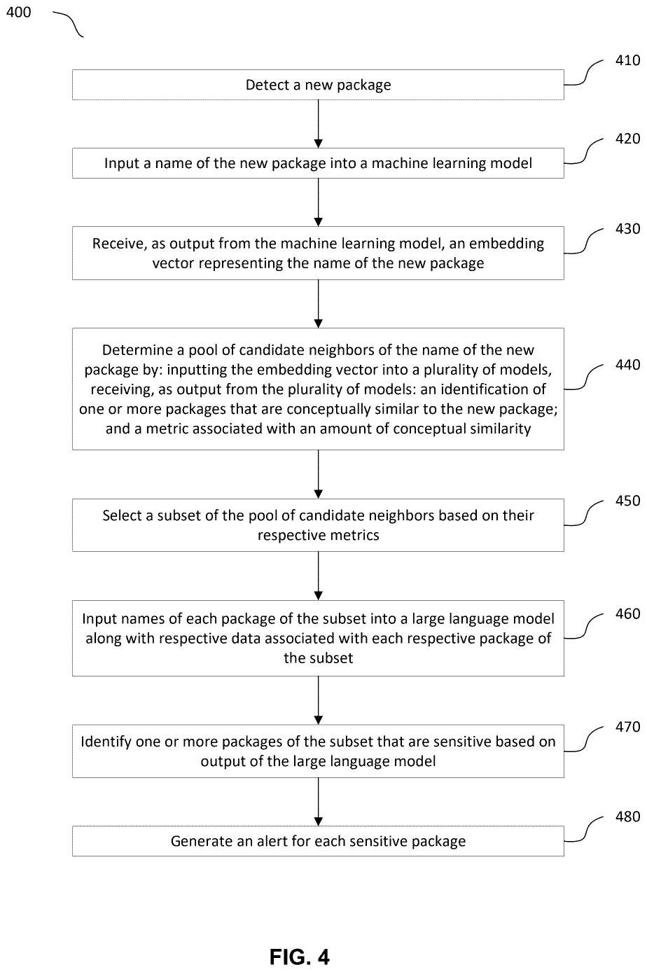

FIG. 4 illustrates an exemplary process for operating the typosquatting detection tool, in accordance with an embodiment. Process 400 may be implemented by one or more processors executing instructions (e.g., encoded in memory of a non-transitory computer-readable medium) that causes the modules of typosquatting detection tool 130 to operate. Process 400 begins with typosquatting detection tool 130 detecting 410 an untrusted package and inputs 420 a name of the untrusted packages into a machine learning model (e.g., using models from embedding generation module 230). The machine learning model herein, includes a language model configured to generate embedding vectors, which are numerical representations of textural data.

Typosquatting detection tool 130 receives 430 receives an embedding vector representing the name of the untrusted package as an output from the machine learning model. Typosquatting detection tool 130 determines 440 a list of candidate neighbors for the untrusted package by inputting the embedding vector into various models (e.g., Levenshtein distance, Cosine similarity, etc.) to capture semantic and syntactic relationships between the package names. The models identify conceptual similarity between the untrusted package and known packages from a database. (e.g., a known package database 220). Typosquatting detection tool 130 receives metadata including an identification whether the untrusted package is identified conceptually similar to one or more known packages, and its corresponding similarity score and/or distance metric that quantifies the degree of similarity. Typosquatting detection tool 130 selects 450 a subset of candidate packages based on the outcomes of various similarity metrics previously used, such as Levenshtein distance.

Typosquatting detection tool 130 inputs 460 names of each candidate package into a LLM along with received metadata. Based on the output from the LLM, typosquatting detection tool 130 identifies 470 one or more packages that are considered sensitive meaning it may pose a risk of targeting a trusted package within the system. In order to determine whether the untrusted package is benign or potentially sensitive, the LLM evaluates contextual signals such as author information, README content, version history and other relevant metadata. For each package that is determined to be sensitive or indicative of a typosquatting attempt, typosquatting detection tool generates 480 an alert for further triage or review.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
detecting an untrusted package;
inputting a name of the untrusted package into a machine learning model;
receiving, as output from the machine learning model, an embedding vector representing the name of the untrusted package;
determining a pool of candidate neighbors of the name of the untrusted package by:
inputting the embedding vector into a plurality of models;
receiving, as output from the plurality of models:
an identification of one or more packages that are conceptually similar to the untrusted package; and
a metric associated with an amount of conceptual similarity;
selecting a subset of the pool of candidate neighbors based on their respective metrics;
inputting names of each package of the subset into a large language model along with respective data associated with each respective package of the subset;
identifying one or more packages of the subset that are sensitive based on output of the large language model; and
generating an alert for each sensitive package.

2. The method of claim 1, wherein determining the pool of candidate neighbors comprises excluding trusted CLI strings from being part of the pool of candidate neighbors notwithstanding any of the trusted CLI strings having a conceptual similarity to the name of the untrusted package.

3. The method of claim 1, wherein determining the pool of candidate neighbors further comprises:
determining a creation date of the untrusted package;
determining a creation date of a suspected package; and
responsive to determining that the creation date of the suspected package predates the creation date of the untrusted package, excluding the suspected package from the pool of candidate packages notwithstanding a name of the suspected package having a conceptual similarity to the name of the untrusted package.

4. The method of claim 1, wherein for each respective package of the subset, the respective data input into the large language model along comprises respective metadata collected for the respective package, the respective metadata including one or more of respective documentation files describing the respective package.

5. The method of claim 1, wherein the plurality of models comprises a semantic similarity model that determines semantic similarity between the name of the untrusted package and a name of a given candidate neighbor.

6. The method of claim 1, wherein the plurality of models further comprises a similarity metric that determines computes Levenshtein distance between the name of the untrusted package and a name of a given candidate neighbor:
preparing a matrix, wherein a first dimension of the matrix represents characters of the name of the untrusted package and a second dimension of the matrix represents characters of the name of the given candidate;
calculating a number of one or more insertions, deletions or substitutions required to transform substrings of the name of the untrusted package into substrings of the name of the given candidate;
filling the matrix, by comparing each character of the name of the untrusted package and the name of the given candidate; and
determining the Levenshtein distance in the matrix.

7. The method of claim 1, wherein identifying one or more packages of the subset that are sensitive based on output of the large language model comprises:
responsive to receiving an output from the large language model that a given package is sensitive, displaying to a user an indication that the given package is sensitive;
receiving an input from the user that confirms that the given package is sensitive; and
responsive to receiving the input, determining that the given package is sensitive.

8. The method of claim 1, wherein the alert is embedded in a feed of sensitive packages, and wherein the feed is sorted based on current interactions with users with the sensitive packages.

9. The method of claim 1, further comprising, responsive to identifying one or more packages of the subset that are sensitive, tagging metadata of an entry in a known packages database with an indication that corresponding package is sensitive.

10. The method of claim 1, wherein generating the alert comprises generating an indication that each sensitive package is a typosquatting of the untrusted package.

11. A non-transitory computer-readable medium comprising memory with instructions encoded thereon that, when executed by one or more processors, causes the one or more processors to perform operations comprising:
detecting an untrusted package;
inputting a name of the untrusted package into a machine learning model;
receiving, as output from the machine learning model, an embedding vector representing the name of the untrusted package;
determining a pool of candidate neighbors of the name of the untrusted package by:
inputting the embedding vector into a plurality of models;
receiving, as output from the plurality of models:
an identification of one or more packages that are conceptually similar to the untrusted package; and
a metric associated with an amount of conceptual similarity;
selecting a subset of the pool of candidate neighbors based on their respective metrics;
inputting names of each package of the subset into a large language model along with respective data associated with each respective package of the subset;
identifying one or more packages of the subset that are sensitive based on output of the large language model; and
generating an alert for each sensitive package.

12. The non-transitory computer-readable medium of claim 11, wherein determining the pool of candidate neighbors comprises excluding trusted CLI strings from being part of the pool of candidate neighbors notwithstanding any of the trusted CLI strings having a conceptual similarity to the name of the untrusted package.

13. The non-transitory computer-readable medium of claim 11, wherein determining the pool of candidate neighbors further comprises:
determining a creation date of the untrusted package;
determining a creation date of a suspected package; and
responsive to determining that the creation date of the suspected package predates the creation date of the untrusted package, excluding the suspected package from the pool of candidate packages notwithstanding a name of the suspected package having a conceptual similarity to the name of the untrusted package.

14. The non-transitory computer-readable medium of claim 11, wherein for each respective package of the subset, the respective data input into the large language model along comprises respective metadata collected for the respective package, the respective metadata including one or more of respective documentation files describing the respective package.

15. The non-transitory computer-readable medium of claim 11, wherein the plurality of models comprises a semantic similarity model that determines semantic similarity between the name of the untrusted package and a name of a given candidate neighbor.

16. The non-transitory computer-readable medium of claim 11, wherein the plurality of models further comprises a similarity metric that determines computes Levenshtein distance between the name of the untrusted package and a name of a given candidate neighbor:
preparing a matrix, wherein a first dimension of the matrix represents characters of the name of the untrusted package and a second dimension of the matrix represents characters of the name of the given candidate;
calculating a number of one or more insertions, deletions or substitutions required to transform substrings of the name of the untrusted package into substrings of the name of the given candidate;
filling the matrix, by comparing each character of the name of the untrusted package and the name of the given candidate; and
determining the Levenshtein distance in the matrix.

17. The non-transitory computer-readable medium of claim 11, wherein identifying one or more packages of the subset that are sensitive based on output of the large language model comprises:
responsive to receiving an output from the large language model that a given package is sensitive, displaying to a user an indication that the given package is sensitive;
receiving an input from the user that confirms that the given package is sensitive; and
responsive to receiving the input, determining that the given package is sensitive.

18. The non-transitory computer-readable medium of claim 11, further comprising, responsive to identifying one or more packages of the subset that are sensitive, tagging metadata of an entry in a known packages database with an indication that corresponding package is sensitive.

19. The non-transitory computer-readable medium of claim 11, wherein generating the alert comprises generating an indication that each sensitive package is a typosquatting of the untrusted package.

20. A system comprising:
memory with instructions encoded thereon; and
one or more processors that, when executing the instructions, are caused to perform operations comprising:
detecting an untrusted package;
inputting a name of the untrusted package into a machine learning model;
receiving, as output from the machine learning model, an embedding vector representing the name of the untrusted package;
determining a pool of candidate neighbors of the name of the untrusted package by:
inputting the embedding vector into a plurality of models;
receiving, as output from the plurality of models:
an identification of one or more packages that are conceptually similar to the untrusted package; and
a metric associated with an amount of conceptual similarity;
selecting a subset of the pool of candidate neighbors based on their respective metrics;
inputting names of each package of the subset into a large language model along with respective data associated with each respective package of the subset;
identifying one or more packages of the subset that are sensitive based on output of the large language model; and
generating an alert for each sensitive package.
